(19) United States
(12) Patent Application Publication
(10) Pub. No.: US 2009/0019149 A1
(43) Pub. Date: Jan. 15, 2009

(54) CONTENT DISTRIBUTION AND TRACKING

(75) Inventors: Ran A. Cohen, Kerem Maharal (IL); Yosef Wexler, Shimshit (IL); Amir Shatz, Tzur-Igaal (IL); Amir Dagan, Kibbutz Megiddo (IL); Meir Mendelovich, Rishon Lezion (IL); Yehuda Elmaliach, Hod-Hasharon (IL)

Correspondence Address: DARBY & DARBY P.C., P.O. BOX 770, Church Street Station, New York, NY, 10008-0770, US

(73) Assignee: Mobixell Networks, Ra'anana (IL)

(21) Appl. No.: 11/994,544

(22) PCT Filed: Feb. 13, 2006
(86) PCT No.: PCT/IL06/00182

§ 371 Date: Sep. 29, 2008

Related U.S. Application Data
(60) Provisional application No. 60/705,286, filed on Aug. 2, 2005.

(51) Int. Cl. G06F 15/16

(52) U.S. Cl. 709/224

(57) ABSTRACT

A computer-implemented method for tracking multimedia content includes generating a first feature vector of a first multimedia object, extracting a second multimedia object from a transmission of digital traffic, generating a second feature vector of the second multimedia object, and determining a similarity of the second feature vector to the first feature vector. Responsively to the similarity, the second multimedia object is identified as an instance of the first multimedia object.

### CROSS-REFERENCE TO RELATED APPLICATION

This application claims the benefit of U.S. Provisional Patent Application 60/705,286, filed Aug. 2, 2005, which is incorporated herein by reference.

### FIELD OF THE INVENTION

The present invention relates generally to multimedia distribution and specifically to methods and systems for distribution of multimedia messages over digital networks.

### BACKGROUND OF THE INVENTION

Multimedia-enabled cellular phone systems enable users of phones (also referred to as handsets) to receive multimedia content, including objects such as pictures, music, video, and executable programs. Programs may include games, screen savers, and other software applications. Multimedia Messaging Service (MMS) enables phone users to send and to receive multimedia messages that encapsulate multimedia content. Users may also download to their phones from a content download platform (CDP) multimedia content that is unencapsulated, including background images and ring-tones.

Operators of cellular phone systems may generate revenue by charging users for the receipt and/or transmission of multimedia content. When content is forwarded many times between users, the propagation may be referred to as “viral distribution.”

The Third Generation Partnership Project (3GPP) provides specifications for communications in an MMS Environment (MMSE). In particular, 3GPP Technical Specification (TS) 23.140, “Multimedia Messaging Service Functional Description,” (referred to hereinbelow as 3GPP TS23140), which is incorporated herein by reference, and which is available at www.3gpp.org/specs/specs.htm, provides specifications for communication protocols and functional elements in an MMSE. These specifications have also been generally adapted by other standards-setting bodies, including the Third Generation Partnership Project 2 (3GPP2) and the Open Mobile Alliance (OMA).

A central element of an MMSE is an MMS Relay/Server, referred to hereinbelow as an MMS Center (MMSC). The primary role of the MMSC is to store and to route MMS message.

Digital traffic comprising multimedia messages transmitted between an MMSC and other elements of an MMSE conforms to interface standards defined in 3GPP TS23140. Standards defined for four types of traffic, which are denoted in 3GPP TS23140 as interfaces MM1, MM3, MM4, and MM7, are relevant to the material described hereinbelow.

The MM1 interface is a format for traffic between an MMSC and cellular phones over the Public Land Mobile Network (PLMN). As such, the MM1 interface is the primary interface for delivering multimedia content to and between cellular phone users. The MM1 format is based on HyperText Transfer Protocol (HTTP). Typically, traffic passes from the MMSC to the cellular phones via a Wireless Application Protocol (WAP) Gateway.

MM4 is the interface between MMSC's of different cellular system operators. When a user on a first cellular network sends an MMS message to a user on a second cellular network, an MMSC on the first network forwards the message to an MMSC on the second network according to protocols of the MM4 interface.

MM3 is the interface between an MMSC and an external system, such as the Internet or an e-mail system. Typically, MM3 transmissions utilize Simple Mail Transfer Protocol (SMTP). A content provider that distributes advertising or other types of content by MMS messages may send such messages using the MM3 interface.

MM7 is the interface between an MMSC and an application, referred to as a Value Added Service (VAS), which generates messages automatically, such as notification messages and advertising. While MM3 may also be used for VAS communications, the MM7 interface supports enhanced VAS functions including multi-unicast distribution, authentication, authorization, distribution lists, and delivery response. Like MM1, communications by MM7 are defined to adhere to HTTP.

Multimedia content for MMS communications is delivered as objects conforming to formats specified by the 3GPP Technical Specification (TS) 3GPP TS 26.140, “Multimedia Messaging Service; Media formats and codecs,” which is incorporated herein by reference. Formats are defined for plain text, voice, audio, synthetic audio, still image, bitmap graphics, vector graphics, animation, and video.

Multimedia Message Box (MMBox) is a service enabling users to send MMS messages from their cellular phones to users who receive the messages on their computers by way of the Internet.

PCT Patent Publication WO 02/085046 A1 to Cleary, whose disclosure is incorporated herein by reference, describes a system for associating messages sent to mobile handsets with calling line identification numbers so as to track the return path for the messages. An object of the disclosed invention is to facilitate return messages being sent from a handset to an originating party without the handset having to embed a code in the return message.

### SUMMARY OF THE INVENTION

Embodiments of the present invention provide systems, apparatus, and methods for distributing multimedia content over communication networks, and particularly for tracking the distribution of such content. These embodiments enable network operators to initiate, to promote, and to benefit from viral content distribution.

There is therefore provided, in accordance with an embodiment of the present invention, a computer-implemented method for tracking multimedia content, including:

generating a first feature vector of a first multimedia object;

extracting a second multimedia object from a transmission of digital traffic;

generating a second feature vector of the second multimedia object;

determining a similarity of the second feature vector to the first feature vector; and

responsively to the similarity, identifying the second multimedia object as an instance of the first multimedia object.

Typically, identifying the second multimedia object as an instance of the first multimedia object includes identifying the second multimedia object as a variation of the first multimedia object notwithstanding a difference between the first and second multimedia objects.

In some embodiments, generating the first feature vector includes generating a first coarse feature vector and a first fine feature vector, generating the second feature vector includes generating a second coarse feature vector and a second fine feature vector, and determining the similarity includes determining a coarse similarity between the first coarse feature vector and the second coarse feature vector and subsequently determining a fine similarity between the first fine feature vector and the second fine feature vector. Typically, determining the coarse similarity includes determining that the first multimedia object is a candidate for a process of determining a fine similarity, if the coarse similarity satisfies a predetermined criterion. In some embodiments, the first and second coarse feature vectors each include multiple feature vectors of increasing levels of granularity and determining the coarse similarity includes determining increasingly more granular coarse similarities according to the increasing levels. Generating the first coarse feature vector may include indexing the first coarse feature vector to a group of one or more cells of a hyper-grid, and determining the coarse similarity may include determining that the second coarse feature vector corresponds to at least one index of the group. Alternatively or additionally, generating the first coarse feature vector may include indexing the first coarse feature vector according to a clustered cell of a clustered cell space, generating the second coarse feature vector may include identifying a set of clustered cells overlapped by a region around the second coarse feature vector, and determining the coarse similarity may include determining that the first coarse feature vector is in the set of overlapped clustered cells and within the region around the second coarse feature vector. Generating the coarse feature vector may also include generating a normalized version of the multimedia object, dividing the normalized version into a set of blocks, and summing elements of each block in the set to generate coefficients of the coarse feature vector.

Typically, generating the first feature vector includes storing the first feature vector in a media database, and also includes, responsively to identifying the second multimedia object as a variation of the first multimedia object, storing the second feature vector in the media database with an identifier indicating that the first and second multimedia objects share common content. In some embodiments, the transmission is a first transmission, the similarity is a first similarity, and the method includes extracting a third multimedia object from a second transmission of digital traffic, generating a third feature vector of the third multimedia object, determining a similarity of the third feature vector to the second feature vector, and responsively to determining the similarity, identifying the third multimedia object as an instance of the first multimedia object.

In some embodiments, the transmission is a first transmission and the method includes extracting the first multimedia object from a second transmission of digital traffic generated by a content provider prior to extracting the second multimedia object.

Typically, the method includes logging a record of a tracking event responsively to identifying the second multimedia object as an instance of the first multimedia object, the record includes an identifier of the first multimedia object and an identifier of a sender of the second multimedia object, and the record is used to generate a report on distribution of the first multimedia object.

Typically, the transmission is sent by a user and the method includes rewarding the user responsively to identifying the second multimedia object as an instance of the first multimedia object.

Typically, the first multimedia object is provided by a content provider, and the method includes providing compensation to the content provider responsively to identifying the second multimedia object as an instance of the first multimedia object.

In some embodiments, the first multimedia object promotes goods or services offered by an advertiser, and the method includes charging a fee to the advertiser responsively to identifying the second multimedia object as an instance of the first multimedia object.

Typically, the method includes applying a predetermined rule to the transmission of the second multimedia object responsively to identifying the second multimedia object as an instance of the first multimedia object. In some embodiments, applying the predetermined rule includes locking or deleting the second multimedia object to limit distribution. Alternatively, applying the predetermined rule may include modifying a quality of the second multimedia object. In further embodiments, the transmission includes a multimedia message, and applying the predetermined rule includes adding additional content to the multimedia message. In still further embodiments, the additional content promotes viral distribution of the multimedia message.

There is further provided, in accordance with an embodiment of the present invention, a computer-implemented method for distributing content over a network, including:

receiving content for distribution from a content provider;

distributing the content to one or more first users on the network;

monitoring network traffic transmitted by the one or more first users;

identifying a transmission of the content in the network traffic from at least one of the first users to one or more second users; and

responsively to identifying the transmission of the content, providing respective rewards to both the content provider and to the at least one of the first users.

In some embodiments, providing the respective rewards includes providing to the at least one of the first users a modified price for a network service.

In further embodiments, providing the respective rewards includes providing further content to the at least one of the first users.

Typically, receiving the content includes generating a first feature vector, and identifying the transmission of the content includes generating a second feature vector and further includes determining a similarity of the second feature vector to the first feature vector.

Typically, generating the first feature vector includes storing the first feature vector in a media database, and the method includes, responsively to identifying the transmission of the content, storing the second feature vector in the media database with an identifier indicating that the first and second feature vectors are derived from common content.

Typically, identifying the transmission of the content includes logging a record of the transmission, and the method includes using the record to generate a report on distribution of the content.

Typically, identifying the transmission of the content includes applying a predetermined rule to the transmission of the content. In some embodiments, applying the predetermined rule includes locking or deleting the content to limit distribution. In further embodiments, applying the predetermined rule includes modifying a quality of the content. In still further embodiments, applying the predetermined rule includes adding additional content to the transmission.

There is also provided, in accordance with an embodiment of the present invention, a computer-implemented method for distributing content over a network, including:

distributing content to one or more first users on the network, the content promoting goods or services offered by an advertiser;

monitoring network traffic transmitted by the one or more first users;

identifying a transmission of the content in the network traffic from at least one of the first users to one or more second users; and

responsively to identifying the transmission, providing a reward to the at least one of the first users and charging the advertiser for the transmission.

There is additionally provided, in accordance with an embodiment of the present invention, apparatus for tracking multimedia content, including:

a monitor adapted to monitor a transmission of digital traffic and to extract multimedia objects from the transmission; and

a manager adapted to generate a first feature vector of a first multimedia object, to generate a second feature vector of a second multimedia object extracted from the digital traffic by the monitor, to determine a similarity of the second feature vector to the first feature vector, and, responsively to the similarity, to identify the second multimedia object as an instance of the first multimedia object.

There is moreover provided, in accordance with an embodiment of the present invention, apparatus for distributing content over a network, including:

a monitor adapted to monitor network traffic so as to identify a transmission by one or more first users to one or more second users of content provided for distribution by a content provider; and

a manager adapted, responsively to identification of the transmission of the content, to generate a record indicating respective rewards due to both the content provider and to the at least one of the first users.

There is further provided, in accordance with an embodiment of the present invention, apparatus for distributing content over a network, including:

a monitor adapted to monitor network traffic so as to identify a transmission by one or more first users to one or more second users of content promoting goods or services offered by an advertiser; and

a manager adapted, responsively to identification of the transmission of the content, to generate a record indicating a reward due to the at least one of the first users and a charge to the advertiser for the transmission.

There is moreover provided, in accordance with an embodiment of the present invention, a computer software product, including a computer-readable medium in which program instructions are stored, which instructions, when read by a computer, cause the computer to generate a first feature vector of a first multimedia object, to receive a second multimedia object extracted from a transmission of digital traffic, to generate a second feature vector of the second multimedia object, to determine a similarity of the second feature vector to the first feature vector, and responsively to the similarity, to identify the second multimedia object as an instance of the first multimedia object.

There is also provided, in accordance with an embodiment of the present invention, a computer software product, including a computer-readable medium in which program instructions are stored, which instructions, when read by a computer, cause the computer to identify a transmission over a network by one or more first users to one or more second users of content provided for distribution by a content provider, and responsively to identification of the transmission of the content, to generate a record indicating respective rewards due to both the content provider and to the at least one of the first users.

There is additionally provided, in accordance with an embodiment of the present invention, a computer software product, including a computer-readable medium in which program instructions are stored, which instructions, when read by a computer, cause the computer to identify a transmission over a network by one or more first users to one or more second users of content promoting goods or services offered by an advertiser, and responsively to identification of the transmission of the content, to generate a record indicating a reward due to the at least one of the first users and a charge to the advertiser for the transmission.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for distributing multimedia content, in accordance with an embodiment of the present invention;

FIG. 2 is a block diagram that schematically illustrates of a tracked tracking manager, in accordance with an embodiment of the present invention;

FIG. 3 is a flow diagram of a process for tracking content, in accordance with an embodiment of the present invention;

FIG. 4 is a flow diagram of a process for provisioning tracked multimedia objects, in accordance with an embodiment of the present invention;

FIG. 5 is a communications flow diagram showing communications involved in monitoring a message sent by a user, in accordance with an embodiment of the present invention;

FIG. 6 is a communications flow diagram showing communications involved in monitoring a message delivered to a user, in accordance with an embodiment of the present invention;

FIG. 7 is a communications flow diagram showing communications involved in sending a message between cellular system operators, in accordance with an embodiment of the present invention;

FIG. 8 is a communications flow diagram showing communications involved in sending a message from a content provider, in accordance with an embodiment of the present invention;

FIG. 9 is a schematic diagram of a fixed grid for indexing coarse feature vectors, in accordance with an embodiment of the present invention;

FIG. 10 is a schematic diagram of a space of clustered cells for coarse searching, in accordance with an embodiment of the present invention;

FIG. 11 is a flow diagram of clustered cell vector quantization, in accordance with an embodiment of the present invention; and

FIGS. 12A and 12B are flow diagrams of processes used in viral distribution programs, in accordance with an embodiment of the present invention.

### DETAILED DESCRIPTION OF EMBODIMENTS

In the embodiments of the present invention that are described below, an original multimedia object created by a content provider is provisioned in a repository. Provisioning includes associating with the original object a General Content Identifier (GCID). Provisioning also includes generating and storing feature vectors, and/or a digital signature, of the object. Feature vectors of several levels of granularity may be created so as to facilitate rapid searches through the repository.

After the original object has been provisioned, it is tracked. Tracking comprises monitoring one or more channels of digital traffic, extracting from the traffic all multimedia objects, also referred to hereinbelow as content items, and analyzing the extracted objects to determine whether any are instances of the tracked object. An instance may be a variation of the original object, due to modifications that may be made in transmitting the object through a network, such as a cellular system. Changes may include format changes, such as a change in image format from JPEG to GIF, or a change in video format from MPEG2 to MPEG4 or H.264. Changes may also include changes in resolution. Images may undergo intensity changes; audio clips may undergo volume changes. Images may also be rotated or mirrored. Content quality may be reduced through the reduction of color palette size, through reduction of JPEG or MPEG quality, or through conversion to gray-scale or to black and white. Video quality, in particular, may also be reduced by dropping frames. Object analysis includes generating feature vectors of an object and searching the repository to find provisioned objects with similar feature vectors.

When an instance is identified, an Instance Content Description Record (ICDR) is created to log the event of a tracked object being transmitted through the network. The ICDR includes identifying information regarding the sender and/or recipient, as well as details of the transmission, such as the time and the interface used. If the instance identified is a variation of the original object that has not been identified previously, the variation is also provisioned in the repository and associated with a Variation Content Identifier (VCID), as well as with the GCID.

Content enhancement may also be implemented when an instance of a tracked object is identified. Content enhancement may include improving the quality of an object within its respective multimedia message, or adding content, such as operator notifications and advertisements, to the multimedia message. Security measures may also be implemented, such as locking or otherwise restricting subsequent access to the object.

Based on the ICDR's, statistics are generated that can be used to determine compensation for providers of entertaining content, to determine charges to assess providers of advertising content, and to determine rewards for users who forward tracked objects to support viral distribution. Statistics may also be used to acquire marketing demographic information.

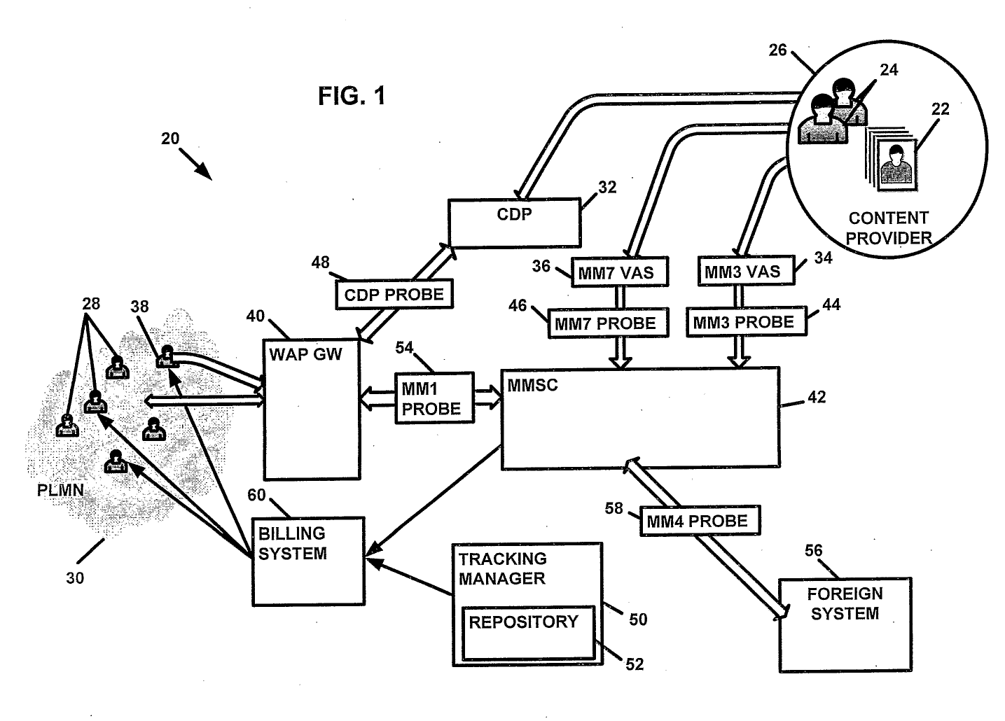

FIG. 1 is a block diagram that schematically illustrates a system 20 for distributing and tracking multimedia content, in accordance with an embodiment of the present invention. In this embodiment, the system is deployed by a cellular system operator, but the principles of the present invention may similarly be applied in other types of communication networks. Content 22 created by developers 24 at a content provider 26 is distributed to users 28 on a Public Land Mobile Network (PLMN) 30. Content 22 comprises multimedia objects that conform to multimedia formats described in the Background, including image, audio, and video objects.

The content may be distributed as messages that are “pushed” to the users. Alternatively, content may be “pulled” by the users from a content download platform (CDP), such as a CDP 32. A Value-Added Service (VAS), such as an MM3 VAS 34 or an MM7 VAS 36, may be used by the content provider to encapsulate the content in multimedia messages, which are pushed to multiple users. A user, such as a user 38, may also provide content by sending content to CDP 32 or through an application that provides public access to a VAS. (A type of application that frequently provides this capability is a blog site.)

Typically, CDP 32 delivers content to a WAP Gateway 40, which provides that content to users 28. The MM3 VAS and the MM7 VAS direct content to an MMSC 42, which in turn delivers messages containing that content to users 28, also by way of WAP Gateway 40. An alternative means for message distribution is by way of a Multimedia Message Box (MMBox), as described in the Background.

Traffic through the MM3 VAS, the MM7 VAS, and the CDP is monitored by provisioning monitors, referred to herein below as provisioning probes, these probes being an MM3 probe 44, an MM7 probe 46, and a CDP probe 48, respectively. Probes 44, 46, and 48 may passively monitor the traffic using methods of TCP sniffing that are known in the art. Alternatively, in some embodiments described further hereinbelow, the probes act as proxies, receiving all traffic in place of the intended destinations and then sending the traffic, including possible modifications, to those intended destinations. Probes may be configured to monitor multiple channels of VAS traffic and may be designed to monitor only that traffic which is transmitted from specific content providers.

Probes 44, 46, and 48 extract multimedia objects from the traffic and transmit these objects to a repository 52 which provisions the objects. Typically objects from these probes comprise original objects created by content providers. Hereinbelow, an original object that has been provisioned is referred to as a tracked object. Provisioning is performed in a manner that permits rapid subsequent identification of instances of the tracked object. An instance may be either an exact copy of an original object or a variation thereof. As is described further hereinbelow, both original objects and their variations are provisioned.

Provisioning of the original object includes generating and storing in repository 52 a new GCID, which is associated with the object. If a message from which the object was extracted also contains meta-data such as an object identification, then the meta-data may also be stored. Provisioning may also include generating and storing a digital signature and a feature vector of the object. Vector quantization may be used to generate feature vectors to represent multimedia objects. A similarity between two multimedia objects may be determined by calculating a difference, such as a Euclidean distance, between their respective vectors. Vector quantization techniques may be used to reduce the dimensionality of the object representation. This may be done by performing a projection from the original high dimensional space to a lower dimension subspace. For example one can discard some less important components in a frequency domain representation. Some common image compression techniques, such as jpeg compression, are based on representing images as spatial frequencies. Granularity of a feature vector is a measure of how much information is contained therein. A feature vector with fine granularity may be used to uniquely identify a multimedia object.

Repository 52 operates in conjunction with a tracking manager 50, described further hereinbelow. In embodiments of the present invention, repository 52 may be implemented either as a component of tracking manager 50 or as a complementary, independent system. Furthermore, tracking manager 50 and repository 52 may be implemented as a distributed processing system, wherein distributed nodes of the repository are co-located with probes to improve real-time performance. Repository 52 is built according to methods known in the art for real-time processing so that the tracking process has a minimal affect on the speed of traffic.

After an original object is provisioned, traffic between users is monitored to identify any exact or modified instances of the object. As noted above, content may be modified by MMSC 42 before being sent to a user, according to the type of the user's handset, for example. Consequently, viral distribution of multimedia content may generate many instances of a tracked object that are variations of the original object.

Traffic between users is monitored by tracking monitors, referred to herein below as tracking probes, these probes being an MM1 probe 54 and an MM4 probe 58. MM3 probe 44 may also monitor user traffic, such as user messages sent to e-mail or to and from MMBox servers. The purpose of tracking is to identify instances of tracked objects. The tracking probes, like the provisioning probes, may passively monitor the traffic using methods known in the art, such as TCP sniffing. In alternative embodiments, tracking probes are designed as proxies, such as TCP/IP proxies, which receive all traffic in place of the intended destinations and then send the traffic, including possible modifications, to those intended destinations.

MM1 probe 54 monitors inbound and outbound traffic between MMSC 42 and WAP Gateway 40. Objects in outbound traffic may have been modified by the MMSC based on limitations in the target handset. Objects in inbound traffic may have been modified due to handset limitations that were not handled by the MMSC. MM4 probe 58 monitors communications with a foreign MMSC 56 according to the MM4 protocol described in the BACKGROUND

MM1 probe 54 and MM4 probe 58 extract objects from their respective traffic flows and transmit these objects to repository 52. Repository 52 then determines whether these extracted objects are instances of tracked objects.

When an extracted object is determined to be an instance of a tracked object, processing rules determined by tracking manager 50 may be implemented, whereby probes 54 and 58, designed as proxies, may modify the message containing the instance.

Tracking manager 50 may also issue alarms, as described further hereinbelow. In order to generate subsequent statistics related to the tracked object and to determine rewards, the tracking manager also creates an ICDR, as described above. ICDR's may subsequently be sent to billing system 60. In one embodiment, “hot-billing” is implemented whereby the billing system receives a real-time feed of statistical data from tracking manager 50.

If the identified instance is a variation of the tracked object, the variation is provisioned by assigning to the variation a VCID, which is associated with the GCID of the target object. Provisioning also includes generating and storing feature vectors of the variation in repository 52.

The information in billing system 60 may be used to reward users 28 for forwarding tracked content, for example by reducing MMS charges, thereby providing incentives for viral distribution. Alternatively or additionally, rewards may be provided on the basis of reports generated directly from the tracking manager.

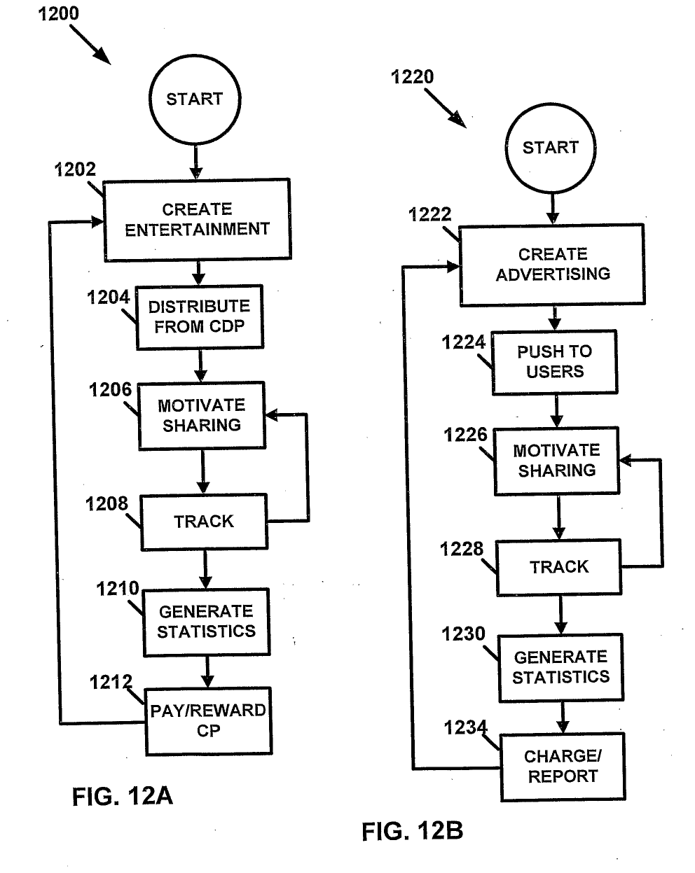

Billing information may also be used to pay or to charge content providers. Examples of reward programs and of billing applications of system 20 are described further hereinbelow with respect to FIGS. 12A and 12B.

The components of system 20 that are described hereinabove, such as probes 44, 46, 48, 54 and 58 and tracking manager 50, typically comprise general-purpose computers with appropriate communication interfaces, as will be apparent to those skilled in the art. The general-purpose computers carry out the functions described herein under the control of software, which may be downloaded to the probes and manager in electronic form, over a network, for example, or alternatively may be provided on tangible media, such as optical, magnetic, or electronic memory media. Further alternatively, some of the functions of the probes and manager may be carried out by dedicated or programmable circuit hardware.

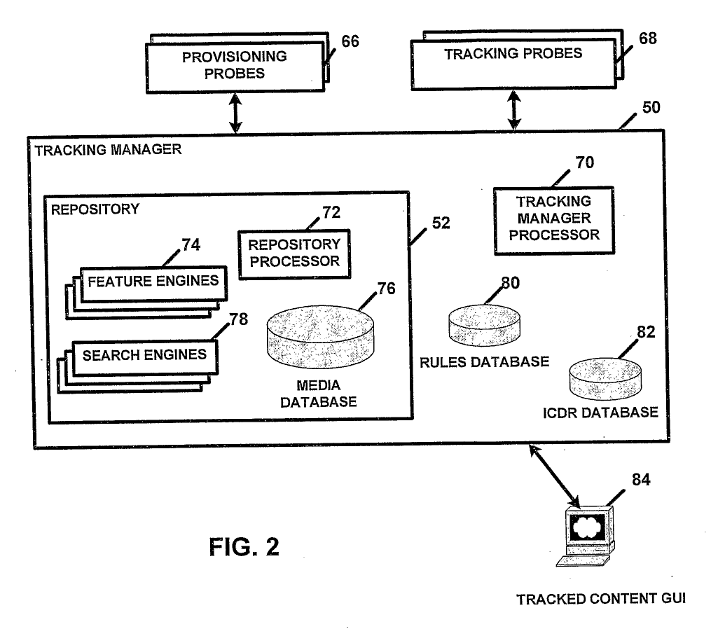

FIG. 2 is a block diagram that schematically shows details of tracking manager 50, in accordance with an embodiment of the present invention.

Provisioning probes 66, comprising MM3 probe 44, MM7 probe 46, and CDP probe 48, for example, deliver objects for provisioning to a repository processor 72, which controls processing performed by repository 52. Hereinbelow, actions ascribed to repository 52 are assumed to be implemented by repository processor 72 unless otherwise indicated.

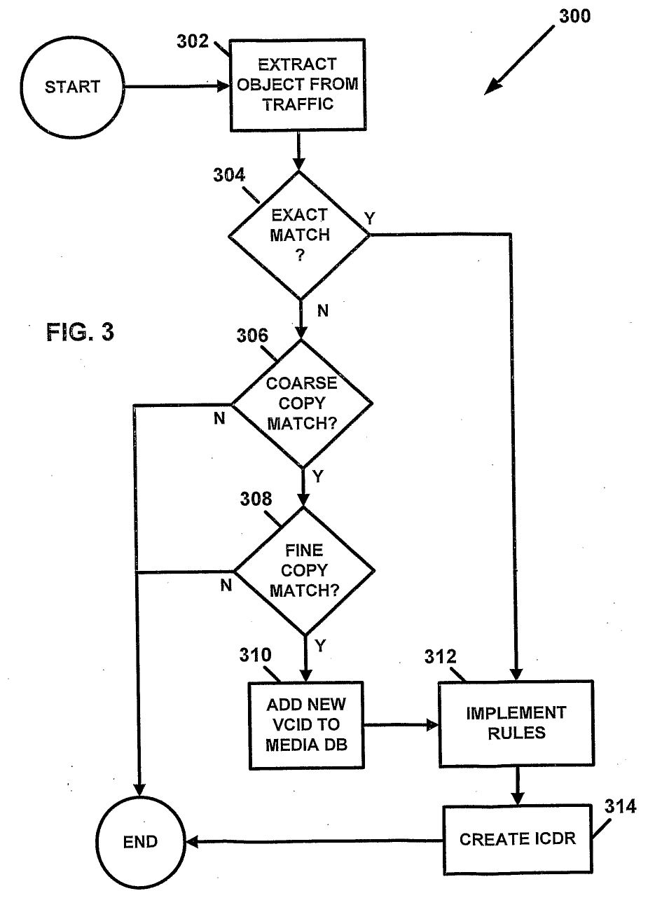

Repository processor 72 utilizes feature engines 74 to generate feature vectors for objects being provisioned. Typically a different feature engine is provided for each type of object that may be tracked. Types typically include image, audio, and video. In embodiments of the present invention, both coarse and fine feature engines are used to calculate feature vectors of different granularities for an object. Feature vectors facilitate subsequent identification of tracked object instances, as described hereinbelow with respect to FIG. 3.

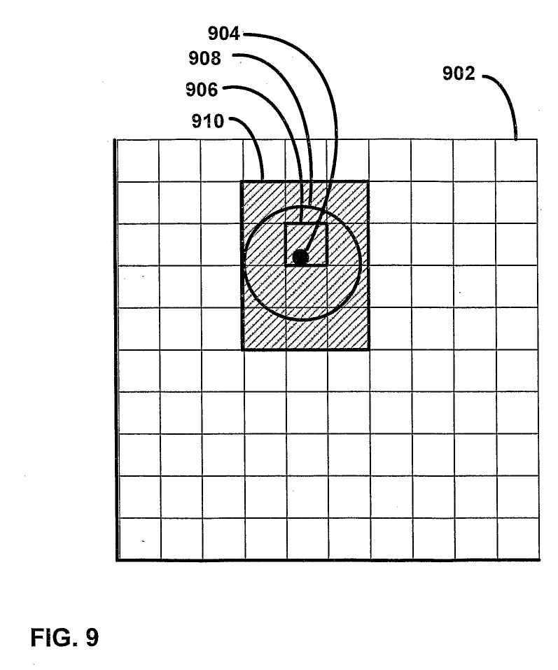

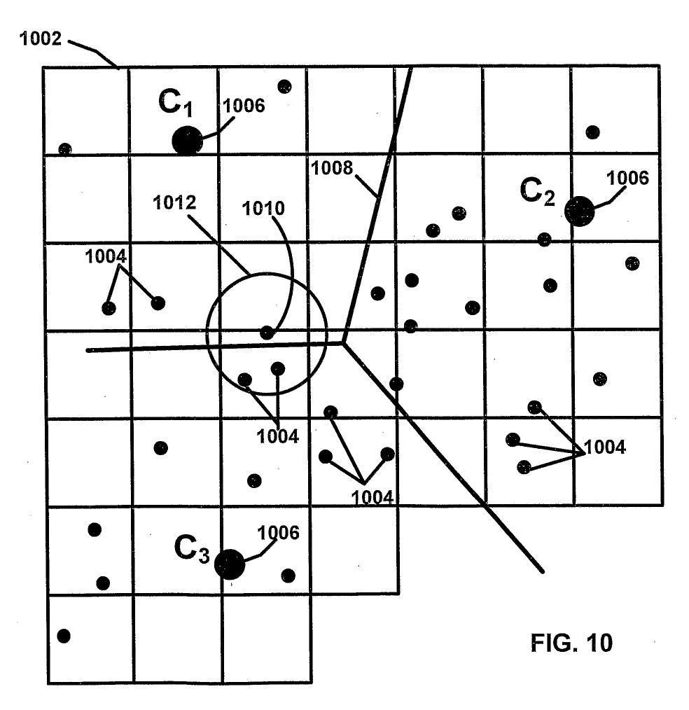

Feature vectors are stored in a media database 76, which is constructed so as to maintain clusters of feature vectors, as described further hereinbelow with respect to FIGS. 9 and 10. Methods for generating feature vectors, particularly coarse feature vectors are also described further hereinbelow (with respect to FIGS. 9, 10, and 11). Other methods that may be used for generating feature vectors, particularly fine feature vectors, are described in a U.S. provisional patent application entitled, “Non-Intrusive Methods for Matching Modified Multimedia Content,” filed Feb. 7, 2006, which is assigned to the assignee of the present patent application and whose disclosure is incorporated herein by reference.

Repository processor 72 may also store in media database 76 a digital signature of the object, such as a checksum code, which enables exact matches of provisioned objects to be quickly identified. Typical checksum codes that may be utilized include 32-bit cyclic redundancy check (CRC-32) code, Message Digest Algorithm 4 (MD4), or Message Digest Algorithm 5 (MD5), various implementations of which are available as open source code over the Internet.

Typically, provisioning also comprises storing in media database 76 the object itself in binary format.

Tracking probes 68, comprising MM1 probe 54 and MM4 probe 58, for example, extract objects from traffic conveyed to and from users 28. An extracted object is delivered to repository 52 to determine whether it is an instance of a tracked object. Feature engines 74, described above, generate feature vectors appropriate for the extracted object. Using the feature vectors, search engines 78 then perform processes described further hereinbelow (FIGS. 9 and 10) to search media database 76 for a tracked object corresponding to the extracted object.

After an extracted object is determined to be an instance of a tracked object, tracking manager 50 is notified that it should provision the instance. Processing by tracking manager 50 is controlled by a tracking manager processor 70, which is typically a software component of the tracking manager. Hereinbelow, actions ascribed to manager 50 are assumed to be implemented by tracking manager processor 70 unless otherwise indicated.

The tracking manager processor may also refer to a rules database 80 to determine whether the probe should modify the object or the encapsulating message, or both.

Rules may be specific to the target object, or may be related to the content provider, the sender, or the receiver. Rules may also depend on the number of instances identified or on the age of the tracked object.

Content enhancement determined by the rules may include modifying the quality of the object. Alternatively or additionally, enhancement may include the addition of content, such as operator notifications and advertisements in the form of slide images, to the multimedia message. The added content may be any type of multimedia content (including images, audio, video, and programs) and may be integrated into the message in the form of a slide that automatically appears before or after the original content.

Security measures may also be implemented, include locking, encoding, or otherwise restricting subsequent access to the object. Locking may be performed using MMS protocols for digital rights protection, in accordance with the Digital Rights Management protocols promulgated by OMA, for example.

Measures may also include deleting the object from the encapsulating message, for example, when an object is considered to be offensive. An object extracted by MM4 probe 58 may be also be removed from it encapsulating message, because it is delivered outside of the PLMN managed by the operator.

Tracking manager processor 70 may also generate an ICDR as described above (FIG. 1), which is stored in an ICDR database 82. Statistics may subsequently be extracted from ICDR database 82 and transmitted to billing system 60 or used to generate reports directly from the tracking manager.

A tracked content Graphical User Interface (GUI) 84 is used to administer elements of tracking manager 50. For example, GUI 84 is used to oversee performance of tracking manager elements and to generate periodic and ad-hoc reports from repository 52 and from ICDR database 82. GUI 84 may also be used to load tracked objects directly into repository 52. In addition, GUI 84 is responsible for loading rules into rules database 80.

As described above, rules determine how probes (configured as proxies) may modify, enhance, or secure content. Content enhancement may include addition of multimedia objects, such as slide images, to MMS messages. Rules database 80 is typically configured to store such content additions, which may be loaded from GUI 84.

Rules may also specify conditions under which tracking manager 50 may send alarm notifications either to GUI 84 or to other elements internal or external to the system. For example, an object may be provisioned specifically in order to block any instances of the object from being distributed. An alarm may be issued to a content provider if an instance is identified in subsequent traffic.

Rules may also specify content aging, whereby tracking of a tracked object may be discontinued and the object may be deleted from repository 52 after a certain period, which may be defined as a period subsequent to the last detection. Alternatively or additionally, tracking may be discontinued after a certain number of instances have been identified in monitored traffic. GUI 84 may also be used to manually delete tracked objects from the repository.

In an embodiment of the present invention, GUI 84 is a web-based application allowing authorized administrators to have access from multiple locations.

FIG. 3 is a flow diagram of a content tracking process 300, in accordance with an embodiment of the present invention. This process is carried out by tracking probes 68 in conjunction with tracking manager 50 and repository 52 in order to determine whether objects extracted from traffic by the tracking are instances of tracked objects. At a step 302, an extracted object is sent to repository 52. At a match step 304, repository 52 generates a digital signature of the object, such as a CRC-32 code, and determines whether the extracted object is an exact copy of an object provisioned in the repository. The provisioned object may be either an original object or a variation. In either case, if an exact match is made, the extracted object is an instance of a tracked object, and the yes branch of step 304 is followed to a rules implementation step 312. Rules may be implemented to enhance or to secure the object and/or the message in which it is encapsulated, as described above with respect to FIG. 2.

Also following identification of the instance, a step 314 is performed, whereby an ICDR is created and added to ICDR database 82.

If the extracted object is not an exact match of a provisioned object, then feature vector searches are performed to determine whether the extracted object is a new (i.e., previously unprovisioned) variation of a tracked object. Typically, both coarse and fine searches are performed. A coarse search determines if there are any candidate target objects that closely match the extracted object. By narrowing the field to a small set of candidates, the coarse search reduces the subsequent load on the fine search. Also, when the coarse search fails to locate any candidates, the computationally-intensive fine search is avoided.

The coarse search, at a step 306, may be further broken into several coarse level stages, to provide a hierarchical filtering of candidates. Two exemplary coarse level stages, as implemented by an embodiment of the present invention, are described hereinbelow with respect to FIGS. 9 and 10.

If the coarse search is successful, one or more candidate tracked objects are passed on to the fine feature vector search at a step 308.

Fine feature vectors comprise sufficient information to determine, with a high degree of statistical certainty, whether or not the extracted object is an instance of one of the candidates determined at step 306. Matching using a fine feature vector search is described in the above-mentioned U.S. provisional patent application entitled, “Non-Intrusive Methods for Matching Modified Multimedia Content.”

If either the coarse or fine feature vector search fails, then the extracted object is rejected by repository 52 and process 300 ends. If, on the other hand, the two search levels are passed successfully, then the extracted object is determined to be a variation of a tracked object. At a step 310, the extracted object is assigned a VCID, which is associated with the GCID of the tracked object, and feature vectors of the variation and the digital signature are provisioned in media database 76. In an alternative embodiment, feature vectors of the extracted object are not provisioned.

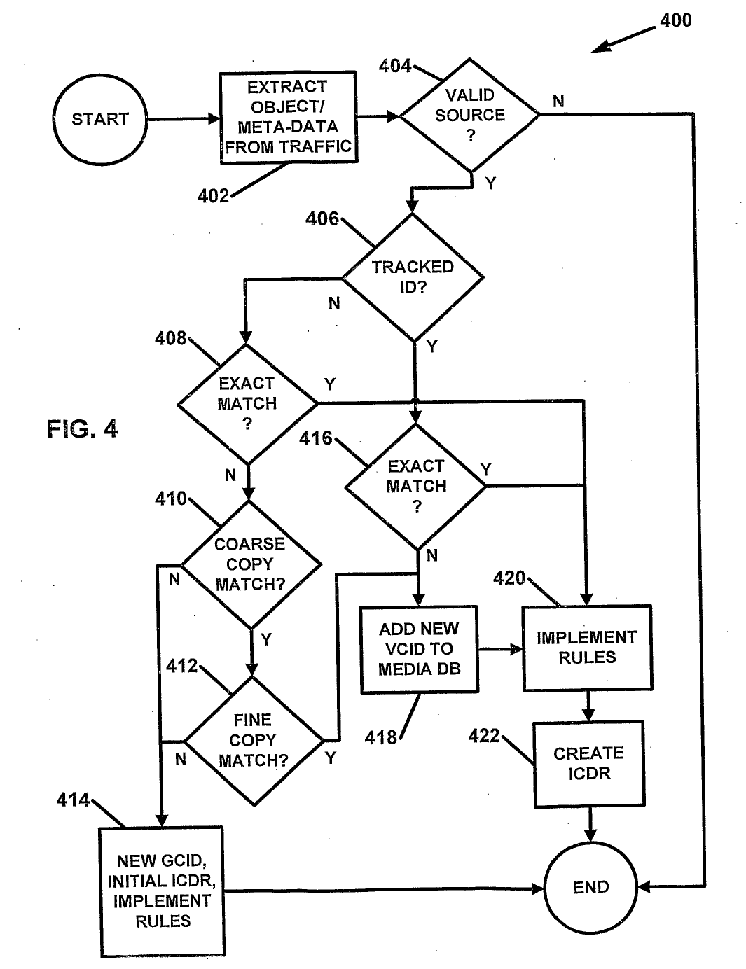

In a further alternative embodiment, when an extracted object is determined to be a variation at step 306, the subsequent step 310 is skipped and the variation is not provisioned. In the second alternative embodiment, variations are only provisioned when detected in provisioning process 400, described below with respect to FIG. 4.

Because the variation is an instance of the tracked object, steps 312 and 314 are implemented as described above. Rules are implemented and a new ICDR is created, after which process 300 ends.

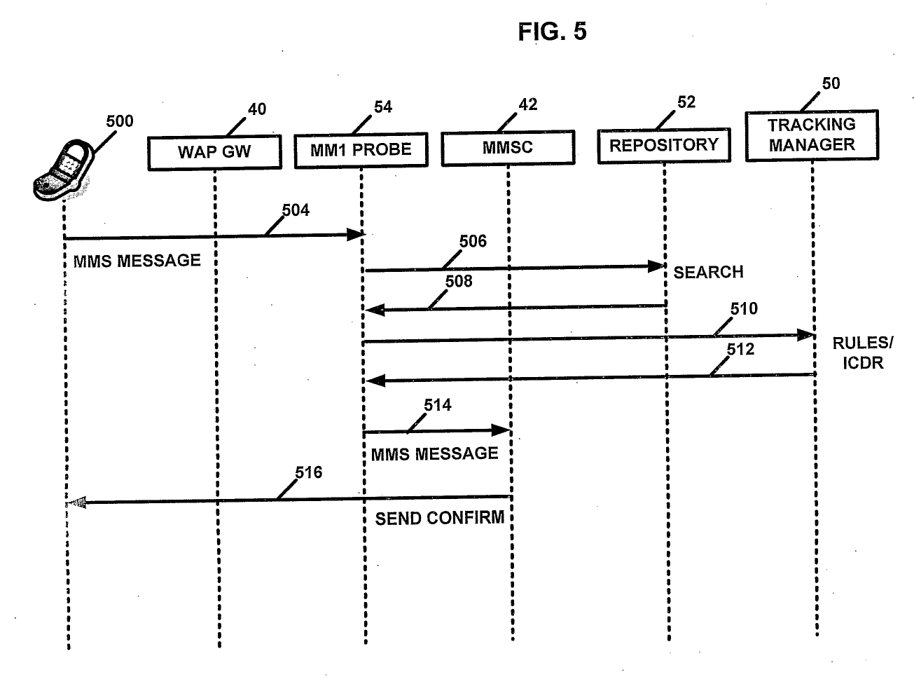

Communications between elements of system 20 during implementation of process 300 are described further hereinbelow with respect to FIGS. 5, 6, and 7.

FIG. 4 is a flow diagram of a content provisioning process 400, in accordance with an embodiment of the present invention. In some embodiments, content providers may be given access to GUI 84, through which original objects may be provisioned directly into repository 52. Process 400 provides an alternative for provisioning original objects, by which provisioning probes 66, in conjunction with tracking manager 50 and repository 52, automatically provision content that content providers place on CDP 32 or send through MM3 VAS 34 or MM7 VAS 36.

At a step 402, an object is extracted from traffic originating from a source such as a content provider 26. The object is typically extracted by one of provisioning probes 66. Typically, the object is extracted together with meta-data such as an address of the source. When the traffic contains transmissions from multiple sources, then a source validation step 404 is performed to confirm that the object originated from a content provider supported by the system. Process 400 ends if the source is not supported.

If the source is supported, then process 400 continues at an identification test step 406, at which an object identification in the meta-data is tested. If the identification does not match that of a tracked object, or if no identification is provided, then identification test step 406 is followed by a match step 408.

Match step 408 and subsequent search steps 410 and 412 parallel the sequence of match step 304 followed by search steps 306 and 308 of process 300. At match step 408, a digital signature of the extracted object is checked to determine whether the extracted object is an exact match of a provisioned object. If there is an exact match, then step 408 is followed by a step 420, at which rules are implemented, and by a step 422, at which an ICDR is logged.

A course feature vector search 410 and a fine feature vector search 412 follow step 408 if the extracted object is not an exact match. If, through these searches, the object is determined to be a new variation of a tracked object then a VCID is provisioned at a step 418, rules are implemented at a step 420, and, at a step 422, an ICDR is created to log the instance of the tracked object.

If, on the other hand, the feature vector searches indicate that the extracted object is not an instance of a tracked object, then, at a step 416, the object is provisioned as a new tracked object. Coarse and fine feature vectors are provisioned in media database 76 and associated with a GCID. Typically, a VCID is also assigned.

Rules may also be implemented as describe above (FIG. 2) based on the content provider identification or based on application information that may be provided by the VAS. Initializing information is also entered into ICDR database 82. After provisioning, process 400 ends.

If the object identification checked at identification test step 406 matches a tracked object, then the feature vector searches may be avoided. An exact match test step 416 is performed to determine whether the extracted object is previously provisioned variation of the tracked object. If not, then the extracted object is provisioned at a step 418, after which steps 420 and 420 are performed. If the object has already been provisioned, step 418 is skipped, and steps 420 and 422 are performed, after which process 400 ends.

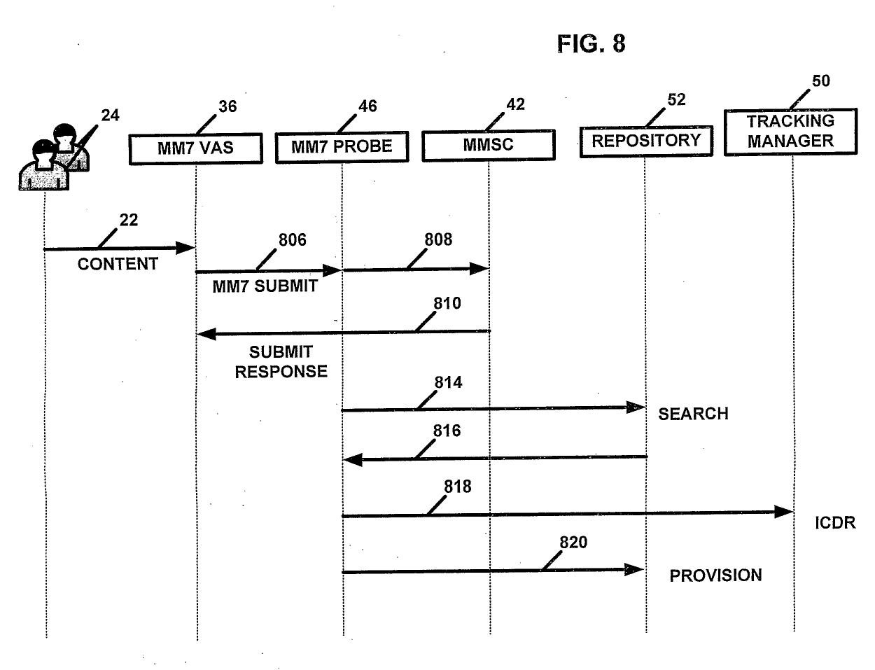

Communications between elements of system 20 during implementation of process 400 is described further hereinbelow with respect to FIG. 8.

FIG. 5 is a diagram that schematically illustrates communications between elements of system 20 when an MMS message sent by one of users 28 is monitored by MM1 probe 54, in accordance with an embodiment of the present invention. Communications are indicated in the diagram as transmissions of multimedia content and of other information.

Communications are initiated by an MMS message 504 sent from a user's handset 500. MMS message 504 reaches WAP Gateway 40 and is directed towards MMSC 42, but is intercepted by MM1 probe 54, which is monitoring traffic between the WAP Gateway and the MMSC. The MMS message encapsulates a multimedia object. In accordance with step 302 of content tracking process 300, MM1 probe 54 extracts the object from the traffic and sends the extracted object by a transfer 506 to repository 52.

Repository 52 performs one or more searches according to steps 304, 306, and 308 of process 300 to determine whether the extracted object is an instance of a tracked object. Repository 52 notifies MM1 probe 54 of the search results in a response 508. When the extracted object is an exact match, repository 52 typically provides a GCID identifying the tracked object and a VCID identifying the particular variation. Often there will be an exact match, because modifications generally are made by the MMSC before objects are delivered, as described above (FIG. 1). If the extracted object is a new variation repository 52 may provision the variation according to step 310 of process 300.

MM1 probe 54 next sends a rule request 510 to tracking manger 50. The rule request includes the GCID and VCID of the tracked object, as well as sender identification. Tracking manager 50 refers to rules database 80 to determine security and enhancement measures that should be taken, as described above with respect to rules implementation step 312 of content tracking process 300. Tracking manager sends the rules and any associated content to MM1 probe 54 in an instruction 512. In parallel, tracking manager 50 may create an ICDR to indicate that a new instance of the tracked object has been identified.

Not shown in the diagram are external notifications, or alarms, that the tracking manager may also send, as described above (FIG. 2), if the rules database 80 has been configured to trigger such notifications.

Upon receiving instruction 512, MM1 probe 54 submits to MMSC 42 an enhanced MMS message 514, which includes the content of original MMS message 504, as well as any content enhancements. If there are no errors in the transmission, MMSC responds with a confirmation 516, which MM1 probe 54 passes on to handset 500 through WAP Gateway 40.

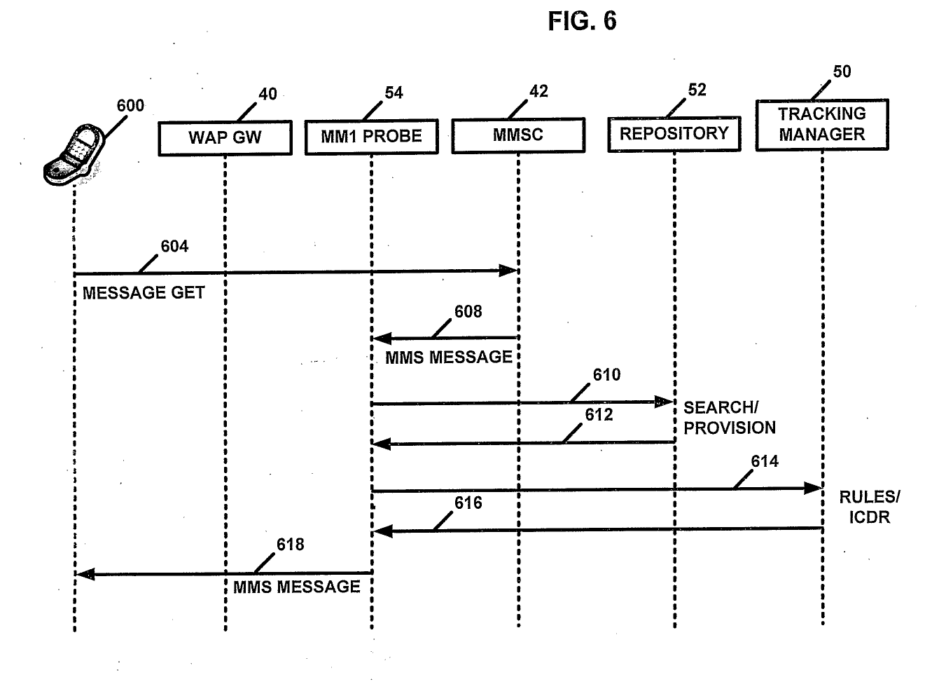

FIG. 6 is a diagram that schematically illustrates communications between elements of system 20 when a retrieved MMS message is monitored by MM1 probe 54, in accordance with an embodiment of the present invention. Before an MMS message is delivered, a user's handset, such as exemplary handset 600, receives a notification that a message is awaiting delivery. Handsets are typically configured to automatically issue a “message get” instruction 604, though some handset may be configured such that an explicit, manual instruction must be issued by the user.

In response to the “message get” instruction, MMSC 42 issues an MMS message 608, which is to be delivered to handset 600 by way of WAP Gateway 40. As noted above, MMSC 42 may modify multimedia objects in a message to suit the capabilities of handset 600. An object encapsulated in message 608 may therefore be a variation of the object encapsulated in the sent message described above with respect to MMS message 504 of FIG. 5.

In accordance with step 302 of content tracking process 300, the MM1 probe extracts the object from message 608 and sends the extracted object by a transfer 610 to repository 52. Repository 52 performs a search according to steps 304, 306, and 308 of content tracking process 300 to determine whether the extracted object is an instance of a tracked object. Repository 52 then notifies MM1 probe 54 of the search result in a response 612.

If the extracted object is an instance of a tracked object, repository 52 provides a GCID identifying the tracked object, and provisions the variation with a new VCID. MM1 probe 54 next sends a rule request 614 to tracking manger 50, which is handled in the manner described above with respect to rule request 510. Tracking manager responds with rule instructions 616. In parallel, tracking manager 50 may create an ICDR for the new instance of the tracked object.

According to the rules instructions received, MM1 probe 54 modifies MMS message 608 appropriately and delivers modified MMS message 618 to handset 600.

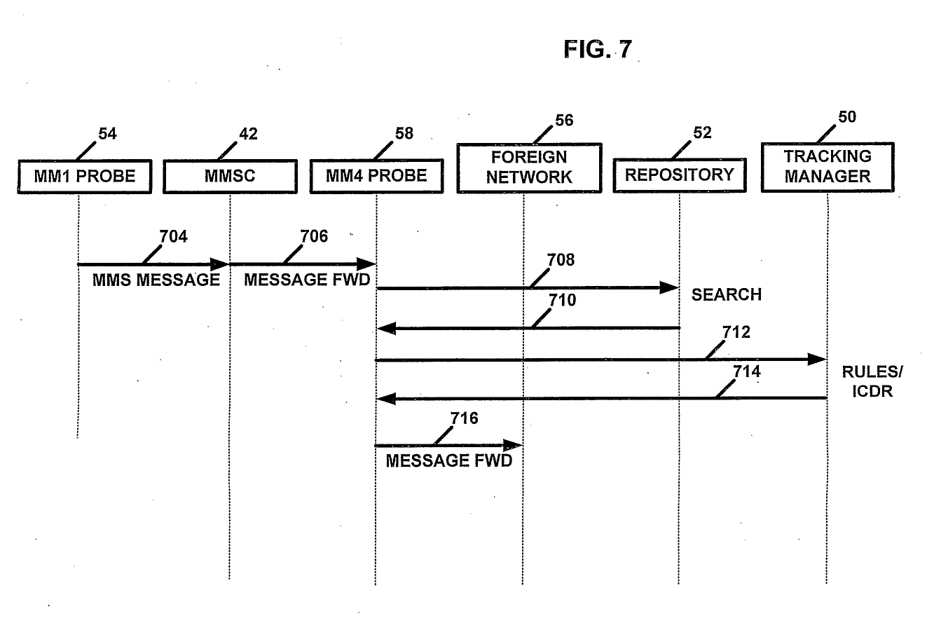

FIG. 7 is a diagram that schematically illustrates communications between elements of system 20 when an MMS message sent to a foreign network is monitored by MM4 probe 58, in accordance with an embodiment of the present invention.

An MMS message 704 arriving at MMSC 42 is destined for a foreign MMSC 56. Typically the message will arrive from MM1 probe 54 after monitoring described above with respect to FIG. 5. The message may also be sent from other probes, or from other sources that are not monitored by probes.

MMSC 42 forwards the message as a forward message 706. MM4 probe 58 intercepts forward message 706 and extracts encapsulated objects.

An extracted object is sent by MM4 in a search instruction 708 to repository 52. Repository 52 returns a response 710 indicating whether or not the object is an instance of a tracked object. When the object is an instance, a rules request 712 is issued to tracking manager 50, which returns rules instructions 714. Often, the instructions will be to block forward transmission of the object (for example, by encoding or deleting the object), as the operator of system 20 may be under an obligation to content providers not to distribute content to a foreign network where objects cannot be tracked. Upon receiving the instructions, MM4 probe 58 forwards message 706, with any modifications, as message 716 to the foreign network

FIG. 8 is a diagram that schematically illustrates communications between elements of system 20 when an MMS message sent by content provider 26 is monitored by MM7 probe 46, in accordance with an embodiment of the present invention. Except as noted specifically hereinbelow, the communication transmissions described below also take place when other provisioning probes, specifically MM3 probe 44 and CDP probe 48, perform the monitoring.

Content 22 created by developers 24 at a content provider 26 is processed by MM7 VAS 36 and forwarded as an MM7 submit request 806 intended for MMSC 42. MM7 probe 46 intercepts request 806 and extracts the multimedia objects encapsulated therein, in accordance with step 402 of content provisioning process 400.

When an extracted object is an unprovisioned, original object, the MM7 probe transfers the submit request as an MM7 submit request 808 to MMSC 42.

In response to submit request 808, MMSC 42 returns a submit response 810 to MM7 VAS 36, which the MM7 VAS may log for purposes of billing and statistics. The CDP and MM3 interfaces typically do not handle a submit response.

MMSC 42 also sends notifications, not shown in the diagram, to intended recipients of an MMS message indicated by the MM7 submit request (as described above with respect to notification message 518 in FIGS. 5 and 6). Typically, an MM7 submit request indicates that the MMS message is to be distributed to multiple users.

Having extracted an original object from submit request 806, MM7 probe 46 initiates provisioning by sending a search instruction 814 to the repository 52. Based on results of the search, which are returned by the repository in a response 816, the probe provides provisioning information in a transfer 818 to tracking manager 50. Tracking manager 50 uses this information to create an ICDR, in accordance with step 414 of content provisioning process 400. If the object is indeed an unprovisioned original object, then a provisioning instruction 820 is sent to repository 52 specifying that the object be added as a new GCID (in accordance with step 412 of process 400). FIG. 9 is a schematic diagram of a fixed grid 902 for provisioning feature vectors so as to implement coarse searches, in accordance with an embodiment of the present invention. Although for visual simplicity, FIG. 9 shows a two-dimensional grid, in practice feature vectors may have three or more dimensions, so that the grid used to provision the feature vectors is a hyper-grid of three or more dimensions. A coarse search for an object under test (typically an extracted object) generates a list of candidates from among the provisioned objects in the media database. The candidates are sufficiently similar to the test object to warrant a subsequent fine search to determine whether the test object is an instance of one of the candidates.

Fixed grid 902 represents a finite space over which feature vectors may be generated for a given type of multimedia object. For each object type, a table of indices representing a grid, such as grid 902, is established in media database 76. Provisioning of an object comprises calculating a coarse feature vector for the object and storing the vector elements indexed to cells of fixed grid 902.

Grid 902 is divided into cells, typically of equal dimensions. Grid sizes are determined to be a convenient fraction of the total range of vector coefficient values. In general, for computational convenience, vector coefficients may be assumed to have integer values.

Point 904 represents coordinates of a feature vector for a provisioned object. As shown in FIG. 9, point 904 falls within a region defined by a cell 906. A threshold radius around point 904 determines a larger region 908. A set 910 of cells defines the cells that fall at least partially within region 908.

In embodiments of the present invention, the object being provisioned is indexed, typically using a hash table, so as to be associated with all of the cells in range 910. As subsequent objects are provisioned, vectors of these subsequent objects may also be indexed to some of the cells in range 910.

Subsequently, to determine whether an extracted object is an instance of a provisioned object, a vector is calculated for the extracted object. A cell associated with this vector is identified, and all objects whose vectors are indexed to this cell are selected as near matches. Near matches may include both original objects and variations. The associated GCID's of all near matches are retrieved. In embodiments of the present invention, all variations of these GCID's are selected as candidates for further analysis by a subsequent fine vector search.

Typically, the threshold radius is selected so that a provisioned object that does correspond to the extracted object will be among the selected candidates. In an alternative embodiment, the provisioned object is indexed to only one cell, i.e., to cell 906. Subsequently, candidates of an extracted object are determined to be provisioned objects indexed to any cell within the threshold radius from the extracted object.

In typical embodiments, grid 902 has five to ten dimensions, corresponding to the number of coefficients used for the coarse vector. For images, for example, the elements of the coarse vector may correspond to the amplitude coefficients of the three lowest spatial frequencies in a Fast Fourier Transform of the image in both the X and Y directions.

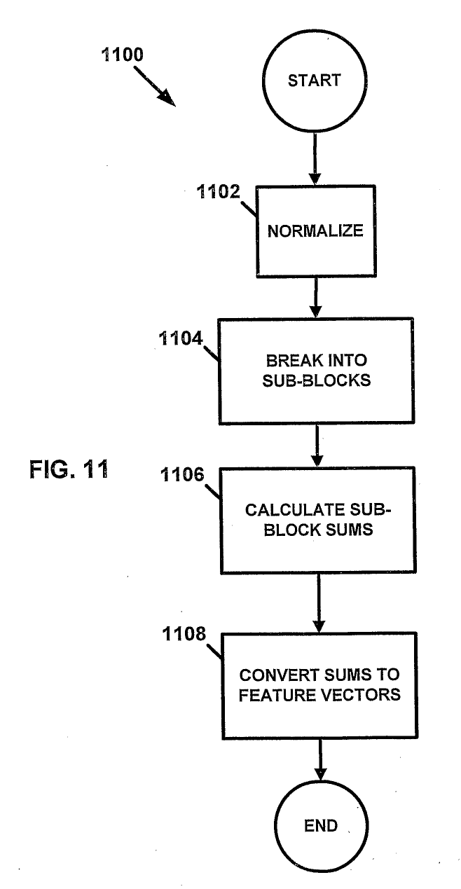

In some embodiments, the grid implementation is combined with a second coarse feature vector implementation, referred to hereinbelow as an clustered cell implementation. Candidates identified by the fixed grid index are subsequently searched using the clustered cell implementation, thereby further reducing the list of candidates for the fine vector search. The combined, hierarchical coarse search permits fast searching in large systems that may track billions of tracked objects, each with tens and possibly hundreds of variations. A description of the clustered cell implementation is described below with respect to FIGS. 10 and 11.

FIG. 10 is a schematic diagram of a multi-dimensional, finite space 1002 comprising clustered cells, over which a coarse vector search is performed, in accordance with an embodiment of the present invention. A clustered cell search may be used as an alternative to the fixed grid search, or may be used in conjunction with the fixed grid search, as described above with respect to FIG. 9. For each object type, tables providing a representation of a clustered cell space, such as space 1002, are established in media database 76.

In embodiments of the present invention, feature vectors 1004 (which have the same number of dimensions as space 1002 itself) are calculated for provisioned objects. Feature vectors may be calculated by a process 1100 described hereinbelow with respect to FIG. 11. The feature vectors are then clustered in space 1002 by generating cell center vectors, represented in the diagram as cell centers 1006.

Cell centers 1006 are determined so as to minimize the sum of all Euclidian distances between all vectors and their clustered cell centers. Minimization-based clustering is disclosed by Gersho and Gray, in Vector Quantization and Signal Compression (Kluwer Academic Press, 1992).

Cell center vectors 1006 are marked in FIG. 10 as C1, C2, and C3. A large repository of multimedia objects may have thousands of cell centers. For example, a typical number of cell centers may be selected as approximately the square root of the number of feature vectors stored in the space. Boundaries 1008 demarcate clustered cells, which comprise the regions that are closer to each respective cell center than to any other cell center.

To determine whether provisioned objects are candidates for a subsequent fine vector search, a clustered cell search is implemented by one of search engines 78 (FIG. 2) according to the type of object being evaluated. The search comprises the following four steps: First, a feature vector for the extracted object is calculated, such as a vector having coordinates indicated by a point 1010. Second, a cell center closest to the vector is determined, thereby determining the cell to which the vector belongs. For example, in the diagram, point 1010 is shown as falling within the boundaries of a cell whose center is C1.

Third, a symmetrical threshold region 1012, centered around point 1010 and having a Euclidian radius of R, is examined to determine whether the region overlaps a neighboring cell. For example, threshold region 1012 is shown in the diagram as overlapping the cell of C3, in addition to C1. Hereinbelow, all cells overlapped by the region with radius R are collectively referred to as active cells.

A typical value for R may be 40000 for a space of 48 dimensions. In the implementation described below with respect to FIG. 11, vector coefficients may range in size from 0 to 65280.

In the fourth step of the search, all vectors in active cells are tested to determine whether they fall within threshold region 1012. (In some embodiments, a second region around point 1010 may be used for this test, rather than threshold region 1012.) All provisioned objects whose vectors fall within this region are determined to be candidates for the fine level search.

Determination of the closest cell center at the second search step may be made in the following manner: A Euclidian-based distance between the feature vector of the extracted object and a first cell center is calculated as a sum of squared differences of the respective coefficients of the two vectors. This distance is set as a metric, to which the distances between the feature vector of the extracted object and each of the remaining cell centers in the space are compared. The distances to each of the remaining cell centers are calculated, and any distance determined to be less than the metric is made the new metric.

Several short-cuts may be used to improve the speed of the search. First, as sums of squares are calculated for a given distance, the calculation is halted if a partial sum exceeds the metric distance plus 2*R. Second, all distances that are less than the metric plus 2*R are saved in a list, referred to hereinbelow as a candidate cell list. After the distances to all centers have been calculated, the list is reviewed to delete any that exceed a sum of the metric plus 2*R. Only the remaining cells in the candidate cell list need to be tested to determine whether they are active cells.

A further filter may be used to narrow the candidate cell list by testing whether a cell j meets the condition defined by the following equation:

Dⱼ<R+Rⱼ,

wherein Dⱼ is the Euclidian distance between the extracted object vector and the cell center of cell j, R is the Euclidian radius of the threshold region, as described above, and Rⱼ is the distance between the cell center of cell j and the most distance vector in the cell.

A test of whether a cell j in the candidate cell list is an active cell is performed by determining whether cell j meets the condition defined by the following equation, derived from Euclidian geometry:

Dⱼ²−Dₘ²<2RDₘⱼ,

wherein Dₘ is the metric described above as the distance from point 1010 to the cell center of the closest cell m, and Dₘⱼ is the distance between cell centers of cells j and m, respectively.

In embodiments of the present invention, the squared Euclidian distances, Dⱼ², are the values previously saved in the clustered cell list. Values for all Dₘⱼ may be stored in advance, further reducing the active cell search time.

In some embodiments, a redistribution of clustered cells is performed automatically during the course of operations. Redistribution is performed after a sufficient number of new objects have been provisioned and/or deleted from the clustered cell space, such that the space no longer meets the criterion that was used for its generation. A redistribution may include recalculation of the number of cells and/or the locations of the cell centers (and thus the cell boundaries). Repository 52 may be configured to perform the redistribution automatically by periodically testing the impact of changes after a certain number of changes are made.

For example, every time a preset number of changes in the repository, such as 100 changes, have been made, a test may be made to determine by how much the sum of all Euclidian distances to cell centers has changed. If the change is greater than a certain amount, such as 2%, then a redistribution may be performed.

FIG. 11 is a flow diagram of a process 1100 for clustered cell vector quantization, in accordance with an embodiment of the present invention. Process 1100 may be performed by one of feature engines 74 of repository 52 to generate feature vectors both for provisioning and for searching in the clustered cell space. Process 1100 is designed for vector quantization of images, but may be modified according to methods described hereinbelow for other types of media.

At an initial step 1102, an image is normalized to generate a reduced image, for example, an image having dimensions of 64×64 pixels. Each pixel comprises three bytes, which each represent one of three color components, such as red, green, and blue. Each byte can assume a value of 0 to 255.

Next, at a step 1104, the reduced image of 64×64 pixels is divided into 16 blocks, each having dimensions of 16×16 pixels. Each block thus comprises 16×16=256 pixels. Because each pixel comprises three colors, there are essentially 16 blocks for each color, or a total of 48 distinct color pixel blocks corresponding to the reduced image.

Next, at a step 1106, for each of the 48 distinct color blocks, the sum of all distinct color pixels in the block is calculated. The total range of values for any block sum is 0 to 65280, as there are 256 pixels in each block, each having a range of 0 to 255.

At a step 1108, a 48-dimension feature vector is constructed, with the 48 sums as the respective coefficients. This completes process 1100.

For video objects and graphic animation objects, process 1100 may be implemented by using only one frame of the object, such as the first video frame. For audio objects, a frame may be constructed as a brief initial period of the audio signal, such as the first 20 ms. Frequency components may then be used instead of pixels in subsequent calculations to create a feature vector. In an alternative embodiment, several such audio frames may be used to generate the feature vector.

FIGS. 12A and 12B are flow diagrams of processes for viral distribution of entertaining content and of advertising content, respectively, in accordance with an embodiment of the present invention.

FIG. 12A represents a process 1200 whereby entertaining content may be virally distributed. Operators frequently provide entertaining content, also referred to as premium content, on CDP's. Entertaining content may include appealing music, images or video clips. As handset technology improves, content may also include full-length video programs and movies. Users are generally charged a premium price for downloading, or “pulling” this content, and some of the revenues may be distributed to the content providers (typically the owners or licensors of the content). Revenue distribution, or pricing discounts, may also be provided to users who forward content to other users.

At a step 1202, entertaining content is created and provisioned in the repository, after which it is provided at a step 1204 to users who download the content from a CDP. During the download, a CDP probe may add promotional content, such as image slides, to the premium content. Promotional material may inform the user of benefits and rewards that the user gains by forwarding the content to others. For example, a user who frequently forwards content may get free access to certain content, or may get discounts on certain downloads. The promotional content is added in accordance with predefined rules, as described above.

When the promotional material reaches the user at a step 1206, the user is encouraged to share the content. Additional motivational incentives may include charging the user only a minimal price, such as the standard MMS price, for forwarding the content. A lead user who downloads content rather than receiving it through viral distribution may get an additional discount. Additional pricing methods to motivate distribution, while also maintaining a level of income for the operator, may include offering users a discount for forwarding the content to a certain minimal number of other users, or changing the price once the general distribution has reached a certain number of users.

As users begin to forward the content to others, distribution of the content is tracked at a step 1208, according to the methods of tracking described hereinabove. With each forward transmission, monitoring probes may add promotional information to the transmitted message, further promoting continued viral distribution in a process indicated in the diagram by the iterative loop between steps 1206 and 1208.

In addition to the process of content enhancement oriented towards promoting viral distribution, other actions based on rules implementation may also be performed. In addition, each time the content is forwarded (or, more precisely, each time an instance of a tracked object is identified in the traffic through system 20) an ICDR is generated to log the event. The ICDR may log information such as the transmission interface, the sender and the receiver of the content, and other billing information, such as promotions and pricing in effect for the given transmission.

At a step 1210, statistics based on the ICDR records are generated. These statistics are then used at a step 1212 to provide the rewards promised to users, while also charging users based on the promoted tariffs, and to compensate content providers. Compensation to content providers may be based on a percent of total revenues accrued by the system operator in charges to users for distribution of the content, or on tariffs related to the extent of the distribution, such as the number of times a given item of content was forwarded through the network. The compensation serves to further encourage additional content creation, as indicated in the diagram by the process loop from step 1212 to initial content creation step 1202.

Without implementations of the present invention, operators may prefer to lock entertaining content so that it can only be acquired by users who pay the download price. By contrast, the present invention allows broad distribution of entertaining content through viral distribution, from user to user, while also providing operators a means for billing and compensating content providers and users for such distribution. The key to this scheme is the tracking process that efficiently identifies different instances of a given item of content, as described above, as these different instances are created and forwarded from user to user.

FIG. 12B represents a process 1220 whereby advertising content may be virally distributed. Operators may allow advertisers to distribute advertising content, either by attaching it to premium content, or by sending (“pushing”) it directly to users. Typically, advertisers are charged for this distribution. Process 1220 permits advertisers to reach a larger and often better-targeted audience through viral distribution.

At a step 1222, a content provider creates advertising content, which is then provisioned in the repository, through a process such as provisioning process 400 (FIG. 4). Subsequently, at a step 1224, the content is distributed to users. Typically, the content will be delivered from an MMSC and will pass through an MM1 probe, as described above with respect to FIGS. 1-3. The MM1 probe may add additional content to the message to encourage viral distribution of the advertising content. For example, a slide image inserted after the advertising content may inform the user of special promotions. One promotion, for example, may be to provide a user who forwards content with credits that can be redeemed for free premium content. Another promotion may be discounts on MMS charges for self-generated content.

As users are motivated to forward the content on to others, the system tracks the transmissions, as indicated by a step 1228. Tracking and motivation are iterated, while the system concurrently performs additional actions of rule implementation and ICDR generation.

At a step 1230, statistics are generated, and are used at a step 1234 to determine billing of advertisers and rewards for users. In addition, statistics can be aggregated to provide advertisers with valuable information related to the distribution of their content, information that may also be correlated to statistics about users. The provision of this information benefits advertisers, who are thereby encouraged to advertise more and thus provide additional revenue for the operator. Statistics may also be correlated with information in product sales databases that may be maintained by advertisers, or by the operator itself. The correlation may allow the advertisers, or operator, to provide rewards to a user based on purchases made by recipients of messages from the user.

Although the embodiments described above relate specifically to the distribution of MMS messages, the principles of the present invention may also be applied to types of messages in other networks, particularly in circumstances in which multimedia content may be modified during transmission and in which tracking of such content may be beneficial. Furthermore, although these embodiments make reference to certain types of communication networks and protocols, the principles of the present invention may likewise be applied in the context of networks and protocols of other types.

It will thus be appreciated that embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A computer-implemented method for tracking multimedia content, comprising:
generating a first feature vector of a first multimedia object;
extracting a second multimedia object from a transmission of digital traffic;
generating a second feature vector of the second multimedia object;
determining a similarity of the second feature vector to the first feature vector; and
responsively to the similarity, identifying the second multimedia object as an instance of the first multimedia object.

2. The method of claim 1, wherein identifying the second multimedia object as an instance of the first multimedia object comprises identifying the second multimedia object as a variation of the first multimedia object notwithstanding a difference between the first and second multimedia objects.

3. The method of claim 2, wherein generating the first feature vector comprises generating a first coarse feature vector and a first fine feature vector, and wherein generating the second feature vector comprises generating a second coarse feature vector and a second fine feature vector, and wherein determining the similarity comprises determining a coarse similarity between the first coarse feature vector and the second coarse feature vector and subsequently determining a fine similarity between the first fine feature vector and the second fine feature vector.

4. The method of claim 3, wherein determining the coarse similarity comprises determining that the first multimedia object is a candidate for a process of determining a fine similarity if the coarse similarity satisfies a predetermined criterion.

5. The method of claim 3, wherein the first and second coarse feature vectors each comprise multiple feature vectors of increasing levels of granularity and wherein determining the coarse similarity comprises determining increasingly more granular coarse similarities according to the increasing levels.

6. The method of claim 3, wherein generating the first coarse feature vector comprises indexing the first coarse feature vector to a group of one or more cells of a hyper-grid, and wherein determining the coarse similarity comprises determining that the second coarse feature vector corresponds to at least one index of the group.

7. The method of claim 3, wherein generating the first coarse feature vector comprises indexing the first coarse feature vector according to a clustered cell of a clustered cell space, wherein generating the second coarse feature vector comprises identifying a set of clustered cells overlapped by a region around the second coarse feature vector, and wherein determining the coarse similarity comprises determining that the first coarse feature vector is in the set of overlapped clustered cells and within the region around the second coarse feature vector.

8. The method of claim 3, wherein generating the coarse feature vector comprises generating a normalized version of the multimedia object, dividing the normalized version into a set of blocks, and summing elements of each block in the set to generate coefficients of the coarse feature vector.

9. The method of claim 2, wherein generating the first feature vector comprises storing the first 3 feature vector in a media database, and comprising, responsively to identifying the second multimedia object as a variation of the first multimedia object, storing the second feature vector in the media database with an identifier indicating that the first and second multimedia objects share common content.

10. The method of claim 9, wherein the transmission is a first transmission, wherein the similarity is a first similarity, and comprising extracting a third multimedia object from a second transmission of digital traffic, generating a third feature vector of the third multimedia object, determining a similarity of the third feature vector to the second feature vector, and responsively to determining the similarity, identifying the third multimedia object as an instance of the first multimedia object.

11. The method of claim 1, wherein the transmission is a first transmission, and comprising extracting the first multimedia object from a second transmission of digital traffic generated by a content provider prior to extracting the second multimedia object.

12. The method of claim 1, and comprising:
logging a record of a tracking event responsively to identifying the second multimedia object as an instance of the first multimedia object, wherein the record comprises an identifier of the first multimedia object and an identifier of a sender of the second multimedia object; and
using the record to generate a report on distribution of the first multimedia object.

13. The method of claim 1, wherein the transmission is sent by a user, and comprising rewarding the user responsively to identifying the second multimedia object as an instance of the first multimedia object.

14. The method of claim 1, wherein the first multimedia object is provided by a content provider, and comprising providing compensation to the content provider responsively to identifying the second multimedia object as an instance of the first multimedia object.

15. The method of claim 1, wherein the first multimedia object promotes goods or services offered by an advertiser, and comprising charging a fee to the advertiser responsively to identifying the second multimedia object as an instance of the first multimedia object.

16. The method of claim 1, and comprising applying a predetermined rule to the transmission of the second multimedia object responsively to identifying the second multimedia object as an instance of the first multimedia object.

17. The method of claim 16, wherein applying the predetermined rule comprises locking or deleting the second multimedia object to limit distribution.

18. The method of claim 16, wherein applying the predetermined rule comprises modifying a quality of the second multimedia object.

19. The method of claim 16, wherein the transmission comprises a multimedia message, and wherein applying the predetermined rule comprises adding additional content to the multimedia message.

20. The method of claim 19, wherein the additional content promotes viral distribution of the multimedia message.

21. A computer-implemented method for distributing content over a network, comprising:
receiving content for distribution from a content provider;
distributing the content to one or more first users on the network;
monitoring network traffic transmitted by the one or more first users;
identifying a transmission of the content in the network traffic from at least one of the first users to one or more second users; and
responsively to identifying the transmission of the content, providing respective rewards to both the content provider and to the at least one of the first users.

22. The method of claim 21, wherein providing the respective rewards comprises providing to the at least one of the first users a modified price for a network service.

23. The method of claim 21, wherein providing the respective rewards comprises providing further content to the at least one of the first users.

24. The method of claim 21, wherein receiving the content comprises generating a first feature vector, and wherein identifying the transmission of the content comprises generating a second feature vector and further comprises determining a similarity of the second feature vector to the first feature vector.

25. The method of claim 24, wherein generating the first feature vector comprises storing the first feature vector in a media database, and comprising, responsively to identifying the transmission of the content, storing the second feature vector in the media database with an identifier indicating that the first and second feature vectors are derived from common content.

26. The method of claim 21, wherein identifying the transmission of the content comprises logging a record of the transmission, and comprising using the record to generate a report on distribution of the content.

27. The method of claim 21, wherein identifying the transmission of the content comprises applying a predetermined rule to the transmission of the content.

28. The method of claim 27, wherein applying the predetermined rule comprises locking or deleting the content to limit distribution.

29. The method of claim 27, wherein applying the predetermined rule comprises modifying a quality of the content.

30. The method of claim 27, wherein applying the predetermined rule comprises adding additional content to the transmission.

31. A computer-implemented method for distributing content over a network, comprising:
distributing content to one or more first users on the network, the content promoting goods or services offered by an advertiser;
monitoring network traffic transmitted by the one or more first users;
identifying a transmission of the content in the network traffic from at least one of the first users to one or more second users; and
responsively to identifying the transmission, providing a reward to the at least one of the first users and charging the advertiser for the transmission.

32. Apparatus for tracking multimedia content, comprising:
a monitor adapted to monitor a transmission of digital traffic and to extract multimedia objects from the transmission; and
a manager adapted to generate a first feature vector of a first multimedia object, to generate a second feature vector of a second multimedia object extracted from the digital traffic by the monitor, to determine a similarity of the second feature vector to the first feature vector, and, responsively to the similarity, to identify the second multimedia object as an instance of the first multimedia object.

33. The apparatus of claim 32, wherein the manager is adapted to identify the second multimedia object as an instance of the first multimedia object by identifying the second multimedia object as a variation of the first multimedia object notwithstanding a difference between the first and second multimedia objects.

34. The apparatus of claim 33, wherein the manager is adapted to generate the first feature vector by generating a first coarse feature vector and a first fine feature vector, and to generate the second feature vector by generating a second coarse feature vector and a second fine feature vector, and wherein the manager is further adapted to determine the similarity by determining a coarse similarity between the first coarse feature vector and the second coarse feature vector and by determining subsequently a fine similarity between the first fine feature vector and the second fine feature vector.

35. The apparatus of claim 34, wherein the manager is adapted to determine the coarse similarity by determining that the first multimedia object is a candidate for a process of determining a fine similarity if the coarse similarity satisfies a predetermined criterion.

36. The apparatus of claim 34, wherein the first and second coarse feature vectors each comprise multiple feature vectors of increasing levels of granularity and wherein the manager is adapted to determine the coarse similarity by determining increasingly more granular coarse similarities according to the increasing levels.

37. The apparatus of claim 34, wherein the manager is adapted to generate the first coarse feature vector by indexing the first coarse feature vector to a group of one or more cells of a hyper-grid, and to, determine the coarse similarity by determining that the second coarse feature vector corresponds to at least one index of the group.

38. The apparatus of claim 34, wherein the manager is adapted to generate the first coarse feature vector by indexing the first coarse feature vector according to a clustered cell of a clustered cell space, and to generate the second coarse feature vector by identifying a set of clustered cells overlapped by a region around the second coarse feature vector, and wherein the manager is further adapted to determine the coarse similarity by determining that the first coarse feature vector is in the set of overlapped clustered cells and within the region around the second coarse feature vector.

39. The apparatus of claim 34, wherein the manager is adapted to generate the coarse feature vector by generating a normalized version of the multimedia object, by dividing the normalized version into a set of blocks, and by summing elements of each block in the set to generate coefficients of the coarse feature vector.

40. The apparatus of claim 33, wherein the manager is adapted to generate the first feature vector by storing the first feature vector in a media database, and wherein the manager is further adapted, responsively to identifying the second multimedia object as a variation of the first multimedia object, to store the second feature vector in the media database with an identifier indicating that the first and second multimedia objects share common content.

41. The apparatus of claim 40, wherein the transmission is a first transmission, wherein the similarity is a first similarity, and wherein the monitor is adapted to extract a third multimedia object from a second transmission of digital traffic, and wherein the manager is adapted to generate a third feature vector of the third multimedia object, to determine a similarity of the third feature vector to the second feature vector, and responsively to determining the similarity, to identify the third multimedia object as an instance of the first multimedia object.

42. The apparatus of claim 32, wherein the transmission is a first transmission, and wherein the manager is adapted to extract the first multimedia object from a second transmission of digital traffic prior to the extraction of the second multimedia object from the first transmission.

43. The apparatus of claim 32, wherein the manager is adapted to log a record of a tracking event responsively to identifying the second multimedia object as an instance of the first multimedia object, wherein the record comprises an identifier of the first multimedia object and an identifier of a sender of the second multimedia object, and wherein the manager is further adapted to use the record to generate a report on distribution of the first multimedia object.

44. The apparatus of claim 32, wherein the transmission is sent by a user, and wherein the manager is adapted to generate a record indicating a reward due to the user responsively to identifying the second multimedia object as an instance of the first multimedia object.

45. The apparatus of claim 32, wherein the first multimedia object is provided by a content provider, and wherein the manager is adapted to generate a record indicating a compensation due to the content provider responsively to identifying the second multimedia object as an instance of the first multimedia object.

46. The apparatus of claim 32, wherein the first multimedia object promotes goods or services offered by an advertiser, and wherein the manager is adapted to generate a record indicating a charge to the advertiser responsively to identifying the second multimedia object as an instance of the first multimedia object.

47. The apparatus of claim 32, wherein the manager is adapted to apply a predetermined rule to the transmission of the second multimedia object responsively to identifying the second multimedia object as an instance of the first multimedia object.

48. The apparatus of claim 47, wherein the manager is adapted to apply the predetermined rule by locking or deleting the second multimedia object to limit distribution.

49. The apparatus of claim 47, wherein the manager is adapted to apply the predetermined rule by modifying a quality of the second multimedia object.

50. The apparatus of claim 47, wherein the transmission comprises a multimedia message, and wherein the manager is adapted to apply the predetermined rule by adding additional content to the multimedia message.

51. Apparatus for distributing content over a network, comprising:
a monitor adapted to monitor network traffic so as to identify a transmission by one or more first users to one or more second users of content provided for distribution by a content provider; and
a manager adapted, responsively to identification of the transmission of the content, to generate a record indicating respective rewards due to both the content provider and to the at least one of the first users.

52. Apparatus for distributing content over a network, comprising:
a monitor adapted to monitor network traffic so as to identify a transmission by one or more first users to one or more second users of content promoting goods or services offered by an advertiser; and
a manager adapted, responsively to identification of the transmission of the content, to generate a record indicating a reward due to the at least one of the first users and a charge to the advertiser for the transmission.

53. A computer software product, comprising a computer-readable medium in which program instructions are stored, which instructions, when read by a computer, cause the computer to generate a first feature vector of a first multimedia object, to receive a second multimedia object extracted from a transmission of digital traffic, to generate a second feature vector of the second multimedia object, to determine a similarity of the second feature vector to the first feature vector, and responsively to the similarity, to identify the second multimedia object as an instance of the first multimedia object.

54. A computer software product, comprising a computer-readable medium in which program instructions are stored, which instructions, when read by a computer, cause the computer to identify a transmission over a network by one or more first users to one or more second users of content provided for distribution by a content provider, and responsively to identification of the transmission of the content, to generate a record indicating respective rewards due to both the content provider and to the at least one of the first users.

55. A computer software product, comprising a computer-readable medium in which program instructions are stored, which instructions, when read by a computer, cause the computer to identify a transmission over a network by one or more first users to one or more second users of content promoting goods or services offered by an advertiser, and responsively to identification of the transmission of the content, to generate a record indicating a reward due to the at least one of the first users and a charge to the advertiser for the transmission.
